(19) United States
(12) Patent Application Publication
(10) Pub. No.: US 2025/0171707 A1
(43) Pub. Date: May 29, 2025

(54) A METHOD FOR PRODUCING A PEANUT OIL AND PEANUT OIL PRODUCED THEREBY

(71) Applicant: CARGILL, INCORPORATED, Wayzata, MN (US)

(72) Inventors: Junyin CHEN, Nantong (CN); Zhukun MA, Shanghai (CN); Weilin XUE, Nantong (CN); Zhenyu ZHAO, Nantong (CN)

(21) Appl. No.: 18/840,710

(22) PCT Filed: Mar. 2, 2022
(86) PCT No.: PCT/CN2022/078842

§ 371 Date: Aug. 22, 2024

(51) Int. Cl. C11B 1/02; A23D 9/02; C11B 1/06; C11B 3/00

(52) U.S. Cl. CPC C11B 1/025; A23D 9/02; C11B 1/06; C11B 3/008

(57) ABSTRACT

A method for producing peanut oil, peanut oil produced thereof, and use of hydrolases to improve sensory property of peanut oil. Said method includes the steps of providing a peanut water mixture; adding one or more hydrolases to the peanut water mixture; hydrolyzing the peanut water mixture to produce hydrolyzed peanuts; drying the hydrolyzed peanuts to form dried hydrolyzed peanuts; roasting the dried hydrolyzed peanuts to form roasted peanuts; pressing the roasted peanuts to produce crude peanut oil; and filtering the crude peanut oil to form peanut oil.

### FIELD OF THE INVENTION

The present invention generally relates to a method for producing a vegetable oil, and more specifically to a method for producing a peanut oil.

### BACKGROUND OF THE INVENTION

Peanut oil is a vegetable oil made from peanuts. Peanut oil has many health benefits such as being a good source of Vitamin E. Peanut oil also contains high levels of unsaturated fats (both mono- and polyunsaturated fats). Studies have found that increased intake of unsaturated fats in place of saturated fats may help reduce the risk of heart disease and stroke. Peanut oil also contains several bioactive phytosterols, such as β-sitosterol. There are scientific studies showing that β-sitosterol can inhibit cancer growth.

Apart from its nutritional value, peanut oil also has a high smoke point (e.g., around 230° C.). As such, it is a good cooking oil for frying foods.

Refined peanut oil tends to have a bland and neutral flavor, with the nutty aroma and flavor of peanuts removed. Aromatic peanut oil, on the other hand, retains the aroma and flavor of peanuts. Aromatic peanut oil is preferred as a cooking oil in some countries (e.g., China), because of the nutty aroma and flavor it brings to dishes.

Currently, peanut oil with a peanutty and sweet aroma is generally produced through raw material selection and specific processing techniques (e.g., pressing). However, production of aromatic peanut oil by raw material selection heavily relies on the availability of the selected raw materials, and production capacity may thus be compromised by the lack of suitable raw materials. Quite often, the production of aromatic peanut oil requires aroma and flavor enhancement steps used in conventional pressing process. Such aroma and flavor enhancement steps tend to be complex, thereby increasing production costs and reducing production efficiency.

As such, there remains a need for a simple production process of aromatic peanut oil which is capable of delivering enhanced peanut flavor, improving the nutritional value of the obtained peanut oil, increasing oil yield, and/or reducing raw material reliance.

### SUMMARY OF THE INVENTION

An aspect of the present invention relates to a method for producing a peanut oil, including the steps of: providing a peanut water mixture; adding one or more hydrolase to the peanut water mixture; hydrolyzing the peanut water mixture to produce hydrolyzed peanuts; drying the hydrolyzed peanuts to form dried hydrolyzed peanuts; roasting the dried hydrolyzed peanuts to form roasted peanuts; pressing the roasted peanuts to produce crude peanut oil; and filtering the crude peanut oil to form a peanut oil.

Another aspect of the present invention relates to a peanut oil produced according to the present invention.

A further aspect of the present invention relates to use of one or more hydrolases to improve a sensory property of a peanut oil.

### BRIEF DESCRIPTION OF THE DRAWINGS

It will be convenient to further describe the present invention with respect to the accompanying drawings that illustrate possible arrangements of the invention. Other arrangements of the invention are possible and consequently, the particularity of the accompanying drawings is not limiting and is not to be understood as superseding the generality of the preceding description of the invention.

FIG. 1 shows the comparison between the sensory test results of peanut oil produced according to the present invention and peanut oil produced by known production methods in respect of texture and flavor.

FIG. 2 shows the comparison between the sensory test results of peanut oil produced according to the present invention and peanut oil produced by known production methods in respect of flavor.

FIGS. 3A & 3B show the comparison between the sensory test results of peanut oil produced according to the present invention and peanut oil produced by known production methods in respect of aroma.

The drawings herein are for reference purposes only and is not necessarily to scale.

### DETAILED DESCRIPTION OF THE INVENTION

Unless otherwise noted, all measurements, weights, lengths etc. are in metric units, and all temperatures are in degrees Celsius. It is understood that unless otherwise specifically noted, the materials compounds, chemicals, etc. described herein are typically commodity items and/or industry-standard items available from a variety of suppliers and sources worldwide.

An aspect of the present invention relates to a method for producing a peanut oil, including the steps of: providing a peanut water mixture; adding one or more hydrolases to the peanut water mixture; hydrolyzing the peanut water mixture to produce hydrolyzed peanuts; drying the hydrolyzed peanuts to form dried hydrolyzed peanuts; roasting the dried hydrolyzed peanuts to form roasted peanuts; pressing the roasted peanuts to produce crude peanut oil; and filtering the crude peanut oil to form a peanut oil.

In an aspect, providing the peanut water mixture comprises mixing about 1 part by weight peeled peanuts with from about 2 to about 8 parts by weight water; and/or adding one or more hydrolases to the peanut water mixture comprises adding a protease, an amylase and a glucoamylase to the peanut water mixture.

Without intending to be bound by theory, it is believed that the enzymatic hydrolysis of peanuts converts large macronutrients into smaller molecules, which contribute to and/or enhance the flavor and/or aroma of peanuts of the produced oil. Specifically, the inventors of the present invention have found that the addition of protease, amylase and glucoamylase contribute to the generation of key aroma compounds in peanut oil and/or precursors thereof. It should be appreciated that other enzyme(s) may be used in combination or in place of the enzymes recited above, to the extent that such other enzyme(s) may also contribute to the generation of aroma compounds and/or precursors thereof. As such, the use of such other enzymes would also fall within the scope of the present invention.

Without intending to be bound by theory, it is also believed that the enzymatic hydrolysis generates reducing sugars and/or amino acids, with which further chemical reactions may take place during the subsequent roasting step. Such reactions are believed to help release and/or produce more aroma compounds which deliver the flavor and/or aroma of peanuts.

In an aspect of the present invention, the protease is added in an amount of from about 0.0 wt % to about 1 wt %, the amylase is added in an amount of from about 0.01 wt % to about 3 wt %, and the glycoamylase is added in an amount of from about 0.01 wt % to about 4 wt %, by weight of the peanut water mixture. In a specific example, the protease may be added in an amount of from about 0.05 wt % to about 0.5 wt %; or from about 0.1 wt % to about 0.3 wt %. In another specific example, the amylase is added in an amount of from about 0.02 wt % to about 2.5 wt %; or from about 0.04 wt % to about 0.07 wt %. In a further specific example, the glucoamylase is added in an amount of from about 0.05 wt % to about 3.5 wt %; or from about 0.07 wt % to about 0.15 wt %. It should be appreciated that the amount of the protease, amylase and glycoamylase added may at least partly depend on the type and activity of the enzyme and the temperature and the duration of the enzymatic hydrolysis. As such, the specific amounts recited above are for illustrative purposes only, and should not be considered limiting in any way.

In another aspect of the present invention, the hydrolysis of the peanut water mixture is conducted by stirring the peanut water mixture in the presence of the protease, amylase and glucoamylase at from about 25° C. to about 58° C. for from about 2 to about 6 hours. In a specific example, the hydrolysis of the peanut water mixture is conducted at from about 35° C. to about 55° C.; or from about 40° C. to about 50° C. In another example, the hydrolysis of the peanut water mixture is conducted for from about 3 to about 5.5 hours; or from about 3.5 to about 5 hours. A person skilled in the art would understand that the temperature of enzymatic hydrolysis may at least partly depend on the type, amount and activity of the enzyme and the duration of the enzymatic hydrolysis. Likewise, the duration of the enzymatic hydrolysis may at least partly depend on the type, amount and activity of the enzyme and the temperature of the enzymatic hydrolysis. As such, the specific temperature and/or duration recited above are for illustrative purposes only, and should not be considered limiting in any way.

In an aspect of the present invention, the hydrolyzed peanuts are separated from aqueous phase of the peanut water mixture prior to drying. The separation may be achieved by various separation techniques, such as gravity filtration and/or vacuum filtration.

In an aspect of the present invention, the hydrolyzed peanuts are dried at from about 100 to about 120° C. to reach a moisture level of from about 2 wt % to about 8 wt %; or from about 2 wt % to about 5 wt %. It should be appreciated that duration of the subsequent roasting of the dried hydrolyzed peanuts would at least partly depend on the moisture level of the dried hydrolyzed peanuts. As such, the drying and roasting steps may be combined, in which e.g. incremental increase of temperature may be applied. Further, the specific moisture levels recited above are just for illustrative purposes, and should not be considered limiting in any way.

In another aspect of the present invention, the dried hydrolyzed peanuts are roasted at from about 110° C. to about 210° C. for from about 10 to about 45 minutes. In a specific example, the dried hydrolyzed peanuts are roasted at from about 115° C. to about 200° C.; or from about 117° C. to about 155° C. Without intending to be bound by theory, it is believed that Maillard reaction takes place during the roasting of the dried hydrolyzed peanuts. The Maillard reaction refers to an intricate and complex chemical reaction taking place between an amino acid and a reducing sugar. The reaction results in the browning of the food and brings about distinctive flavors. In the present invention, it is believed that reducing sugars and/or amino acids are generated at the enzymatic hydrolysis step, which in turn participate in the Maillard reaction during roasting. The reaction products of the Maillard reaction help elevate the aromaticity and flavor of the obtained peanut oil in the direction of peanuts, which aromaticity and flavor may be well received in certain consumer groups. It is also believed that heating during the roasting step accelerates the Maillard reaction to generate more aromatic small molecules, thereby elevating the flavor and aroma of the produced peanut oil.

In an aspect of the present invention, the crude peanut oil is filtered by centrifuge and/or frame filtration. It should be understood that other filtration techniques may be used, to the extent that the filtration technique separates solid residues from the oil phase of the crude peanut oil.

In another aspect of the present invention, at least a sensory property of the peanut oil is improved, the sensory property of the peanut oil being flavor, aroma, texture, aftertaste and/or mouthfeel.

Another aspect of the present invention relates to a peanut oil produced according to the present invention. The peanut oil produced delivers enhanced flavor and/or aroma of peanuts. As such, it may be particularly suitable for cooking where the dishes require a tinge of the nutty and/or sweet flavor and/or aroma unique to peanuts. For instance, such a peanut oil may be preferred for making salad dressings. However, it may also be preferred for frying and/or cooking foods, elevating their flavor and aroma. Other use of the peanut oil of the present invention including baking and blending it with one or more other editable oils.

A further aspect of the present invention relates to use of one or more hydrolase to improve a sensory property of peanut oil. The sensory property may be flavor, aroma, texture, aftertaste and/or mouthfeel.

### 1) Exemplary Process of Making Peanut Oil

In this example, a combination of two proteases are used. One protease is Protin AY50C, purchased from AMANO ENZYME U.S.A. CO. LTD. Protin AY50C is an alkaline protease preparation, made from fermentation with a strain of Bacillus licheniformis. It has an optimum temperature of 70° C. and an optimum pH of 10.0-11.0. The other protease is ProteAXH, purchased from AMANO ENZYME U.S.A. CO. LTD. ProteAXH is proteolytic enzyme preparation, made from fermentation with a strain of Aspergillus oryzae. It has stable temperature range of 30-60° C. and an optimum pH of 7.0-9.0.

Amylase is KLEISTASE E5NC, purchased from AMANO ENZYME U.S.A. CO. LTD. KLEISTASE E5NC is an endo α-amylase preparation, made from fermentation with a strain of Bacillus amyloliquefactiens. It has an optimum temperature of 70° C. and an optimum pH of 5.5-6.0. Glucoamylase is Gluczyme NL4.2, purchased from AMANO ENZYME U.S.A. CO. LTD. Gluczyme NL4.2 is a glucoamylase preparation, made from fermentation with a strain of Aspergillus niger.

It should be understood that, whilst this example uses a combination of two proteases, either one of the proteases alone used would also work. Further, either one of these proteases would also work in combination with another protease. A person skilled in the art would know how to select the suitable protease for the enzymatic hydrolysis step. As such, the use of the protease combination in this example should not be considered limiting in any way.

In this example, a peanut water mixture is made in a reaction tank by mixing about 2-8 parts by weight water and about 1 part by weight pealed peanuts. About 0.01 wt %-1 wt % protease (a combination of Protin AY50C to ProteAXH in the ratio of 1 to 1 by weight), about 0.01 wt %-3 wt % amylase (i.e., KLEISTASE E5NC) and about 0.01 wt %-4 wt % glucoamylase (i.e., Gluczyme NL4.2), by weight of the peanut water mixture, are added to the peanut water mixture. The peanut water mixture in the presence of the enzymes is stirred in the reaction tank at a temperature of about 25-58° C. for about 2-6 hours for enzymatic hydrolysis. The reaction mixture is filtered to separate hydrolyzed peanuts from water. It should be appreciated that gravity filtration and/or vacuum filtration may be used for this filtration step.

The hydrolyzed peanuts are then dried at about 100-120° C. (e.g., about 105° C.) until the moisture level in the hydrolyzed peanuts reaches about 2 wt %-5 wt %. The dried hydrolyzed peanuts are then roasted at about 110° C.-210° C. (e.g. about 120° C.-150° C.) for about 10-45 minutes (e.g., about 25 minutes). The roasted hydrolyzed peanuts are then pressed to produce crude peanut oil. The crude peanut oil is then centrifuged to remove any remnant solids to produce a centrifuged oil, which is then cooled at about 5-25° C. for about 8-24 hours and then frame filtered to produce the peanut oil. The peanut oil may be optionally refined or subject to any further processing steps prior to use.

### 2) Sensory Assessment of Peanut Oils

In this assessment, two samples of peanut oil, Samples A and B, are prepared according to the method of the present invention. Samples A and B are generally made by the same processing steps, except that Samples A and B are roasted for different durations. Specifically, Sample A is roasted at about 120-150° C. for about 20 minutes, and Sample B is roasted at about 120-150° C. for about 30 minutes.

Samples A and B are assessed in comparison to commercial products A and B. Both commercial products A and B are peanut oils for cooking use currently on the market. Commercial products A and B are both produced around the same time when Samples A and B are produced.

Sensory tests are conducted by a sensory panel to assess the appearance, aroma, texture, mouthfeel, flavor and aftertaste of Sample A, Sample B, commercial product A and commercial products B. The sensory panel consists of 10 trained, experienced panelists who have sensory sensitivity higher than 80% of people. Assessment is conducted by way of quantitative descriptive analysis.

All sensory tests are conducted in an assessment room with good ventilation, such that no odor from the environment would interfere with the assessment of the panelists. The room temperature is set to be from about 20° C. to about 25° C., and is kept quite throughout the entire sensory test. Each panelist does not wear any makeup or other cosmetics with fragrance.

Before assessing a sample, a panelist rinses his or her mouth with water, and chews a biscuit. Every part inside the oral cavity of the panelist should have contacted the crushed biscuit. Then each panelist rinses his or her mouth with water again, and take a break of about 5 minutes before proceeding to test the sample.

When a panelist assesses a sample for its aroma, he or she pours a sample into a transparent vial. He or she then smells the sample as he or she slightly shakes the vial such that air carrying the odor molecules of the sample is slowly inhaled by the panelist. The aroma of a sample is also assessed at elevated temperature by way of a rubbing test. During the rubbing test, a panelist uses a disposable pipette to apply four drops of each sample to the middle of his or her palm. The panelist rubs his or her palms together for 15 seconds such that the temperature of his or her palms increases, and then smells the aroma given off by the sample in his or her palms. He or she then scores the sample for its smell in accordance with the criteria set forth in Table 1 below.

When a panelist assesses a sample for its taste, texture, mouthfeel and aftertaste, he or she takes a sip of the sample, and ensures that the sipped sample slowly flows inside his or her oral cavity and every part thereof should have contacted the sipped sample. Then the panelist spits the sample out. He or she then scores the sample in accordance with Table 1 below.

When a panelist assesses a sample for its appearance, he or she pours a sample into a transparent vial and observes the appearance of the sample. He or she then scores the sample for its appearance in accordance with Table 1 below.

TABLE 1

| Sensory | | |
|---|---|---|
| Attribute | Terminology | Definition |
| Appearance | appearance-color | Various terms used to describe the |
| | | colors of the sample. |
| Aroma | overall aroma | A general term used to describe the |
| | intensity | intensity of the aroma of the sample |
| | | sensed by a panelist. |
| | aroma-raw | A term used to describe a smell |
| | peanuts | associated with raw peanuts. |
| | aroma-roasted | A term used to describe a smell |
| | peanuts | associated with roasted peanuts. |
| | aroma-sesame | A term used to describe a smell |
| | | associated with sesame. |
| | aroma-oily | A term used to describe the smell |
| | | associated with oils. |
| | aroma-green | A term used to describe a smell |
| | | associated |
| | | with fresh plants, such as grass. |
| | aroma-burnt | A term used to describe a smell |
| | | associated with burnt foods. |
| | aroma-rancid | A term used to describe a smell |
| | | associated with rancid oils. |
| Flavor | overall flavor | A term used to describe the |
| | intensity-taste | intensity of the overall flavor |
| | | of the sample. |
| | flavor-raw | A term used to describe a taste |
| | peanuts | associated with raw peanuts. |
| | flavor-roasted | A term used to describe a taste |
| | peanuts | associated with roasted peanuts. |
| | flavor-sesame | A term used to describe a taste |
| | | associated with sesame. |
| | flavor-oily | A term used to describe the taste |
| | | associated with oils. |
| | flavor-green | A term used to describe a taste |
| | | associated |
| | | with fresh plants, such as grass. |
| | flavor-burnt | A term used to describe a taste |
| | | associated with burnt foods. |
| | flavor-peanut | A term used to describe a taste |
| | butter | associated with peanut butter. |
| Texture | texture-thin or | A term used to describe the |
| | thick consistency | consistency of the sample. |
| | texture- | A term sued to describe how |
| | smoothness | smoothly the sample flows within |
| | | the oral cavity of the panelist. |
| | texture- | A term used to describe the greasy |
| | greasiness | feeling when the sample flows within |
| | | the oral cavity of the panelist. |
| | texture- | A terms used to describe the heavy |
| | heaviness | feeling when the sample flows within |
| | | the oral cavity of the panelist. |
| Aftertaste | aftertaste-raw | A term used to describe the aftertaste |
| | peanut | associated with raw peanuts after |
| | | swallowed or spit out. |
| | aftertaste- | A term used to describe the aftertaste |
| | roasted | associated with roasted peanuts after |
| | peanuts | swallowed or spit out. |
| | aftertaste- | A term used to describe the aftertaste |
| | sesame | associated with sesame after |
| | | swallowed or spit out. |
| | aftertaste- | A term used to describe the aftertaste |
| | oily | associated with oils after swallowed |
| | | or spit out. |
| | aftertaste- | A term used to describe the greasy |
| | greasiness | feeling after food is swallowed or |
| | | spit out. |

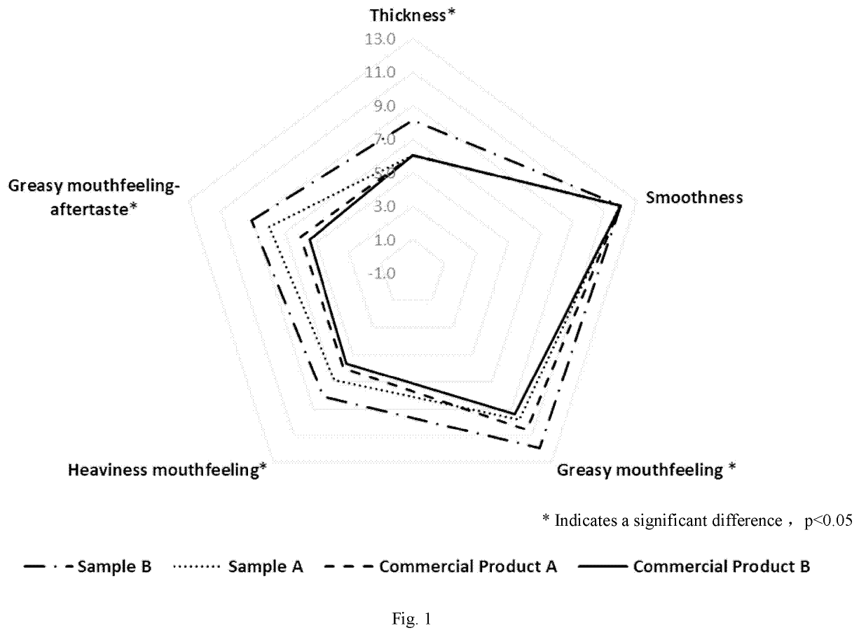

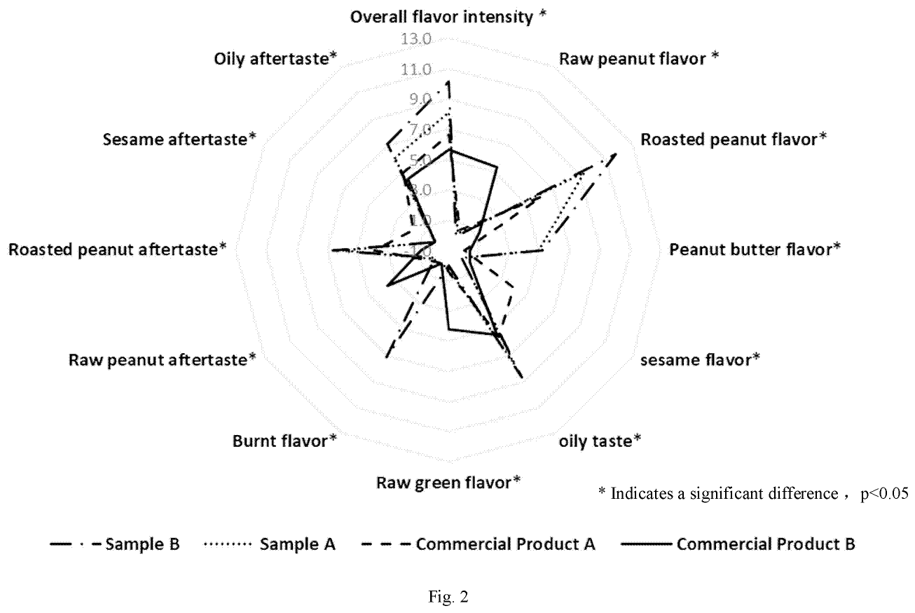

FIG. 1 shows the comparison among Samples A and B and commercial products A and B in terms of their respective texture and mouth feeling. It can be seen that Samples A and B and commercial products A and B are all considered smooth. However, they perform differently in respect of other sensory properties. For consistency, Sample B is the thickest, whilst the thickness of Sample A, commercial product A and commercial product B is found to be almost the same. Regarding heaviness, Sample B is found to deliver the most significant heavy feeling, then the heavy feeling reduces in the order of Sample A, commercial product A and commercial product B. In terms of greasy feeling and greasy aftertaste, Sample B is found to deliver most significant greasy feeling and commercial product B is the least greasy.

FIG. 2 shows the comparison among Samples A and B and commercial products A and B in respect of flavor. For overall flavor intensity, from the strongest to the weakest is Sample B, Sample A, commercial product A, and commercial product B. The Sesame flavor is found to be unique to commercial product A. The flavor of peanut butter is unique to Samples A and B, and Sample B is stronger than Sample A in this respect. The raw peanut flavor and green flavor are unique to commercial product B. In terms of roasted peanut flavor, Sample B is the strongest, followed by Sample A, and commercial product A scores significantly lower than Samples A and B. The burnt flavor is unique to Sample B. For the oily taste, Sample B is the strongest, and Sample A has less oily taste. The commercial products A and B have even less oily taste, and there is no significant difference between the two.

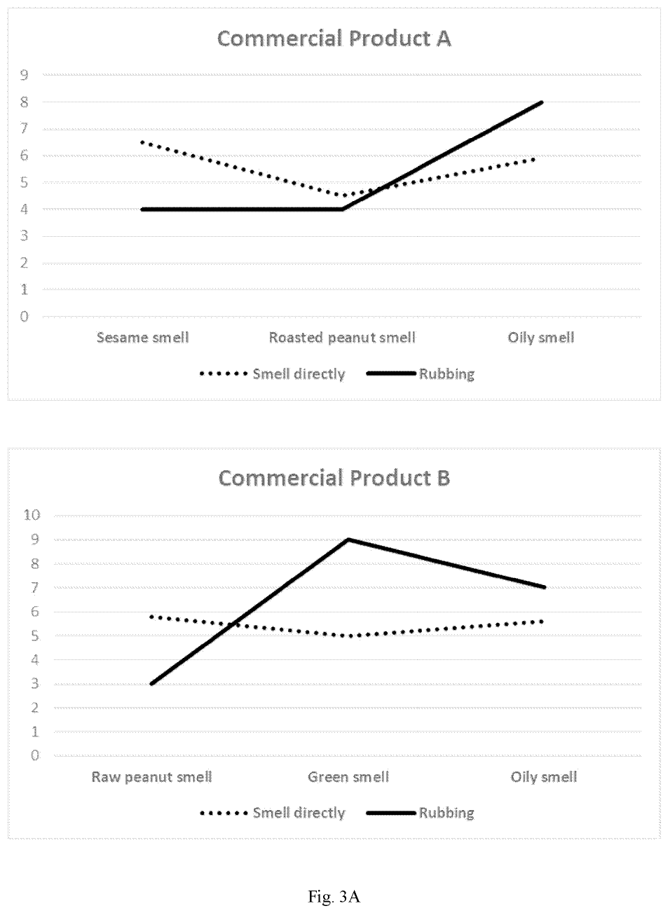

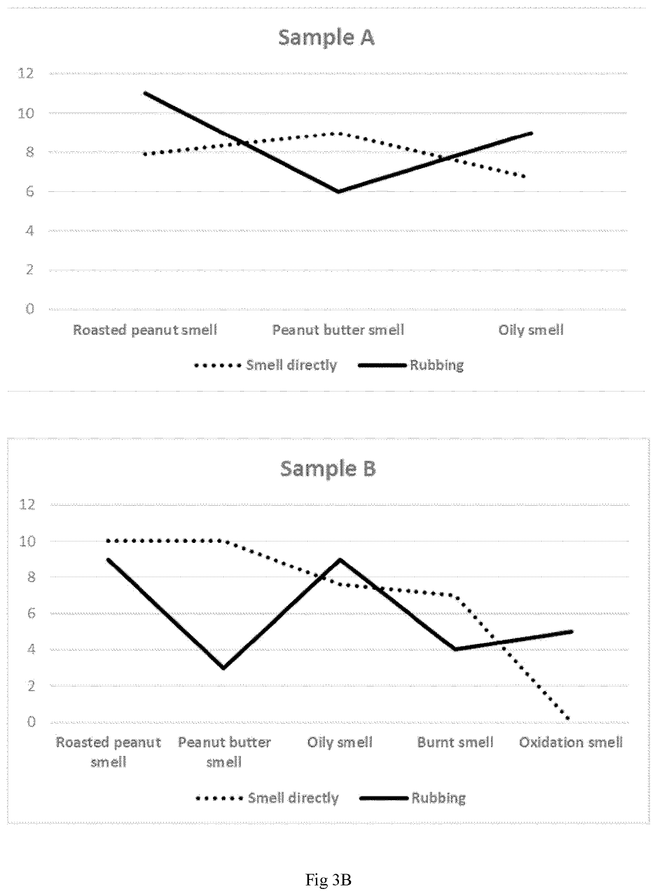

FIGS. 3A and 3B shows the change of aroma profile assessed by directly smelling and by rubbing. For commercial product A, after rubbing, the sesame aroma of commercial product A is significantly weakened, and the aroma intensity of roasted peanuts has not substantially changed. However, the maturity of roasted peanut aroma has changed. Upon directly smelling, commercial product A delivers a freshly ripe peanut aroma. During the rubbing test, commercial product A delivers a half-ripe aroma, and its oily smell is significantly enhanced. During the rubbing test, the peanut aroma of commercial product B is significantly weakened, whilst its green and oily smell significantly enhanced.

After rubbing, the roasted peanut aroma and oily smell of Sample A are significantly enhanced, whilst its peanut butter aroma is obviously weakened. As for Sample B, during the rubbing test the roasted peanut aroma of Sample B remains almost unchanged. However, its oily smell is significantly enhanced. Its peanut butter aroma and burnt smell are significantly weakened.

A summary of the sensory characteristics for each of Sample A, Sample B, commercial product A and commercial product B is as follows in Table 2.

TABLE 2

| | Commercial | Commercial | | |
|---|---|---|---|---|
| | product A | product B | Sample A | Sample B |
| Color | golden | golden | golden | dark orange |
| | yellow | yellow | yellow | yellow |
| overall | medium | weak | strong | very strong |
| aroma and | | | | |
| flavor | | | | |
| intensity | | | | |
| flavor | sesame and | peanuts | peanuts | peanuts |
| direction | peanuts | | | |
| unique aroma | sesame | green taste | maturity of | maturity of |
| and/or flavor | (stronger | | fried or | fried or |
| | aroma | | roasted | overcooked |
| | than taste) | | peanuts, | peanuts, |
| | | | with the | |
| | | | aroma and | with |
| | | | taste of | burnt smell |
| | | | peanut butter | |
| peanut | freshly | raw peanut | roasted | roasted |
| direction | roasted | | peanuts | peanuts |
| | peanuts | | | |
| oily taste | medium | weak | heavy | very heavy |
| and/or smell | | | | |
| Consistency | medium | medium | medium | thickest |
| and/or | | consistency, | consistency, | |
| thickness | | very thick | slightly thick | |
| smoothness | medium | medium | medium | very smooth |
| heavy and/or | medium | medium | slightly | heavy and |
| greasy | | | greasy | greasy |
| feeling | | | | |

It can be seen from the above that peanut oil produced according to the present invention has an enhanced peanut flavor and aroma and a unique sensory profile. As discussed above, such peanut oil may be particularly preferable for dishes to which the nutty and/or sweet aroma is required to elevate their flavor and/or aroma. In addition, the peanut oil prepared according to the present invention may also be particularly suitable for bakery goods, in which nutty flavor and/or aroma and a rich texture would be preferred. For certain cuisines, the peanut oil of the present invention may also be preferred for making salad dressings, due to its peanutty taste and/or aroma.

Apart from the above, the method of the present invention does not require complex flavor and aroma enhancing steps, and is thus readily applicable to existing peanut oil production lines. The production cost of aromatic peanut oil can thus be reduced, and its production efficiency increased. By using such a method, the reliance on raw materials (i.e., peanuts) is also reduced, as the unique flavor and/or aroma of the obtained peanut oil is mainly generated at the enzymatic hydrolysis and/or roasting steps.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

All references specifically cited herein are hereby incorporated by reference in their entireties. However, the citation or incorporation of such a reference is not necessarily an admission as to its appropriateness, citability, and/or availability as prior art to/against the present invention.

1. A method for producing a peanut oil, comprising:
(A) providing a peanut water mixture;
(B) adding one or more hydrolases to the peanut water mixture;
(C) hydrolyzing the peanut water mixture to produce hydrolyzed peanuts;
(D) drying the hydrolyzed peanuts to form dried hydrolyzed peanuts;
(E) roasting the dried hydrolyzed peanuts to form roasted peanuts;
(F) pressing the roasted peanuts to produce crude peanut oil; and
(G) filtering the crude peanut oil to form a peanut oil.

2. The method according to claim 1, wherein:
providing the peanut water mixture comprises mixing about 1 part by weight peeled peanuts with from about 2 to about 8 parts by weight water; and/or
adding one or more hydrolases to the peanut water mixture comprises adding a protease, an amylase and a glucoamylase to the peanut water mixture.

3. The method according to claim 1, further comprising separating the hydrolyzed peanuts before drying.

4. The method according to claim 2, wherein the protease is added in an amount of from about 0.01 wt % to about 1 wt %, the amylase is added in an amount of from about 0.01 wt % to about 3 wt %, and the glycoamylase is added in an amount of from about 0.01 wt % to about 4 wt %, by weight of the peanut water mixture, and wherein the hydrolysis of the peanut water mixture is conducted by stirring the peanut water mixture in the presence of the protease, amylase and glucoamylase at from about 25° C. to about 58° C. for from about 2 to about 6 hours.

5. The method according to claim 2, wherein the protease is added in an amount of from about 0.05 wt % to about 0.5 wt %.

6. The method according to claim 2, wherein the amylase is added in an amount of from about 0.02 wt % to about 2.5 wt %.

7. The method according to claim 2, wherein the glucoamylase is added in an amount of from about 0.05 wt % to about 3.5 wt %.

8. The method according to claim 1, wherein the hydrolysis of the peanut water mixture is conducted at from about 35° C. to about 55° C.

9. The method according to claim 1, wherein the hydrolysis of the peanut water mixture is conducted for from about 3 to about 5.5 hours.

10. The method according to claim 1, wherein the hydrolyzed peanuts are dried at from about 100 to about 120° C. to reach a moisture level of from about 2 wt % to about 8 wt %.

11. The method according to claim 1, wherein the dried hydrolyzed peanuts are roasted at from about 110° C. to about 210° C. for from about 10 to about 45 minutes.

12. The method according to claim 8, wherein the dried hydrolyzed peanuts are roasted at from about 115° C. to about 200° C.

13. The method according to claim 1, wherein the crude peanut oil is filtered by centrifuge and/or frame filtration.

14. The method according to claim 1, wherein at least a sensory property of the peanut oil is improved, the sensory property of the peanut oil being selected from the group consisting of flavor, aroma, mouthfeel, texture, aftertaste and a combination thereof.

15. Peanut oil produced according to claim 1.

16. (canceled)

17. The method according to claim 2, wherein the protease is added in an amount of from about 0.1 wt % to about 0.3 wt %.

18. The method according to claim 2, wherein the amylase is added in an amount of from about 0.04 wt % to about 0.07 wt %.

19. The method according to claim 2, wherein the glucoamylase is added in an amount of from about 0.07 wt % to about 0.15 wt %.

20. The method according to claim 1, wherein the hydrolysis of the peanut water mixture is conducted at from about 40° C. to about 50° C.
